(19) United States
(12) Patent Application Publication
(10) Pub. No.: US 2007/0137416 A1
(43) Pub. Date: Jun. 21, 2007

(54) Universal shift knob adapter insert

(76) Inventor: Shervin Mowzoun, Albuquerque, NM (US)

Correspondence Address: STURM & FIX LLP, 206 SIXTH AVENUE, SUITE 1213, DES MOINES, IA, 50309-4076, US

(21) Appl. No.: 11/022,521

(22) Filed: Dec. 23, 2004

(51) Int. Cl. G05G 1/10; G05G 1/04

(52) U.S. Cl. 74/558.5; 74/543

(57) ABSTRACT

An adapter insert (10) for forming the operative connection between the threaded upper portion (51) of a gear shift rod (50) and the apertured skirt (101) of a gear shift knob (100) wherein, the adapter insert (10) includes a hollow machined aluminum cylindrical collar member (20) having a threaded interior (22) adapted to engage the threaded upper portion (51) of a gear shift rod (50) and further having a plurality of extreme peripheral recesses (23) that are adapted to be engaged by a locking set screw (80) that is threadedly engaged with the apertured skirt (101) of the gear shift knob (100).

### BACKGROUND OF THE INVENTION

### CROSS REFERENCE TO RELATED APPLICATIONS

This invention was the subject matter of Document Disclosure Program Registration No. Please fill in the registration number as Sturm & Fix, LLP, does not have it on file, filed in the United States Patent and Trademark Office on date of filing, 2004.

1. Field of the Invention

The present invention relates to the field of automotive shift constructions in general and in particular to a universal adapter insert for connecting a variety of gear shift knobs to a standard gear shift rod.

2. Description of Related Art

As can be seen by reference to the following U.S. Pat. Nos. 5,284,400; 4,791,826; 6,421,881; 3,900,220, and 4,984,931, the prior art is replete with myriad and diverse gear shift knob and knob adapter arrangements.

While all of the aforementioned prior art constructions are more than adequate for the basic purpose and function for which they have been specifically designed, they are uniformly deficient with respect to their failure to provide a simple, efficient, and practical universal shift knob insert that permits a variety of different gear shift knobs to be mounted on a standard gear shift rod.

As most people in the custom automotive accessory industry are aware, there is a large number of custom made gear shift knobs that are purchased as an after-market item and include a smooth hollow cylindrical plastic collar that is press fit over a gear shift rod and loosens over time creatting a potentially hazardous situation for the operator of the vehicle.

As a consequence of the foregoing situation, there has existed a longstanding need among vehicle customizers and their suppliers for a new and improved universal shift knob adapter insert that is specifically designed to provide a secure connection between a threaded gear shift rod and a wide variety of customized gear shift knobs, and the provision of such an adapter insert is the stated objective of the present invention.

### BRIEF SUMMARY OF THE INVENTION

Briefly stated, the gear shift knob insert that forms the basis of the present invention comprises a machine aluminum cylindrical collar member having a threaded hollow interior wherein, the exterior of the cylindrical collar member is provided with a plurality of peripheral recesses dimensioned to receive the standard set screw that is normally provided on the hollow skirt portion of the customized gear shift knobs available as an after-market item.

As will be explained in greater detail further on in the specification, the threaded hollow interior of the cylindrical collar member will be provided with a range of several different thread pitches to accommodate the different thread pitches that are employed on the threaded gear shift rods produced by the major car manufacturers on both domestic and foreign vehicles so that the cylindrical collar member can be securely fastened thereto in a well recognized fashion.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a perspective view of the adapter insert that forms the basis of the present invention installed on a gear shift;

FIG. 2 is a cross-sectional view taken through line 2-2 of FIG. 1;

FIG. 3 is an exploded perspective view of the arrangement depicted in FIGS. 1 and 2; and,

FIG. 4 is an isolated perspective view of the adapter insert.

### DETAILED DESCRIPTION OF THE INVENTION

As can be seen by reference to the drawings, and in particular to FIGS. 3 and 4, the gear shift knob adapter insert that forms the basis of the present invention is designated generally by the reference number 10. The adapter insert member 10 comprises a hollow cylindrical collar member 20 preferably fabricated from machined aluminum 21 wherein, the collar member 20 has a hollow threaded interior 22 and the exterior surface of the collar member 20 is provided with a plurality of spaced peripheral recesses 23 the purpose and function of which will be described presently.

As can be seen by reference to FIG. 4, the opposite ends of the collar member 20 may be chamfered as at 24 24′ for both practical as well as aesthetic considerations as will also be explained presently.

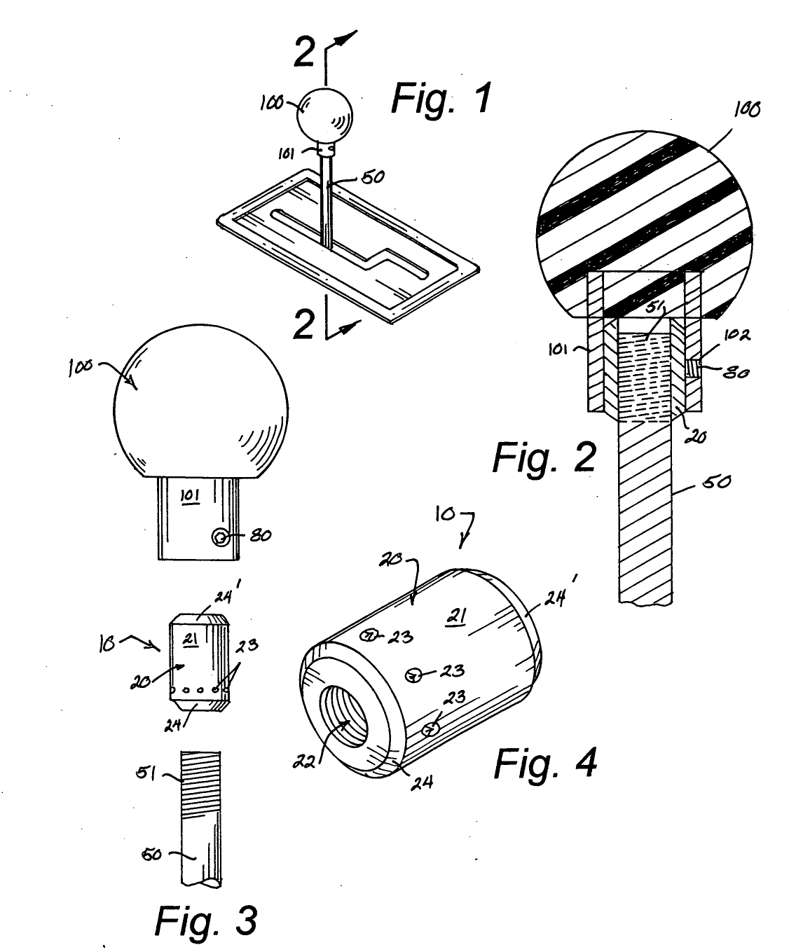

Turning now to FIGS. 1 through 3, it can be seen that the adapter insert 10 is specifically designed to be threadedly engaged with the threaded upper end 51 of a gear shift rod 50 wherein, the chamfered upper end 24′ of the collar member 20 is dimensioned to be slidably received in a press fit fashion with the lower skirt portion 101 of an after-market customized gear shift knob 100.

In addition, as can best be appreciated by reference to FIGS. 2 and 3, the skirt portion 101 of the gear shift knob 100 is further provided with at least one discrete threaded mounting aperture 102 that is dimensioned to receive a set screw 80 that is dimensioned to be received in a selected one of the peripheral recesses 23 in the collar member 20 to lockingly engage the gear shift knob 100 with the exterior of the collar member 20.

At this juncture it should be noted that in the preferred embodiment of the adapter insert 10, the machined aluminum collar member 20 has a height of approximately 1″, a diameter of approximately 0.625 inch and the preferred range of threaded pitches on the interior 22 of the collar member 20 will be between 10×1.25 to 12×1.5 inclusive to accommodate a variety of different makes of vehicles.

By now it should be appreciated that the adapter insert 10 that forms the basis of the present invention provides a stable, rigid, mounting platform for a gear shift knob 100 relative to a gear shift rod 50 that will have an extremely long and useful life when compared to the simple plastic sleeves that are standard equipment on virtually all after-market customized gear shift knobs 100.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

Having thereby described the subject matter of the present invention, it should be apparent that many substitutions, modifications, and variations of the invention are possible in light of the above teachings. It is therefore to be understood that the invention as taught and described herein is only to be limited to the extent of the breadth and scope of the appended claims.

I claim:

1. An adapter insert for operatively engaging a gear shift knob having an apertured skirt portion to a gear shift rod having an upper threaded portion wherein, the adapter insert comprises:
a hollow cylindrical collar member having a threaded interior adapted to engage the upper threaded portion of the gear shift rod wherein, the exterior of the collar member is dimensioned to be slidably received in the apertured skirt portion of the gear shift knob.

2. The adapter insert of claim 1; wherein, the hollow collar member is fabricated from machined aluminum.

3. The adapter insert of claim 1; wherein, the exterior of the collar member is provided with a plurality of peripheral recesses.

4. The adapter insert of claim 2; wherein, the exterior of the collar member is provided with a plurality of peripheral recesses.

5. The adapter insert of claim 3; wherein, the opposite ends of the collar member are chamfered.

6. The adapter insert of claim 4; wherein, the opposite ends of the collar member are chamfered.

7. The adapter insert of claim 5; wherein, the threaded pitch on the interior of the collar member will range between 10×1.25 to 12×1.5.

8. The adapter insert of claim 6; wherein, the threaded pitch on the interior of the collar member will range between 10×1.25 to 12×1.5.
